(19) United States
(12) Patent Application Publication
(10) Pub. No.: US 2018/0336061 A1
(43) Pub. Date: Nov. 22, 2018

(54) STORING FILE PORTIONS IN DATA STORAGE SPACE AVAILABLE TO SERVICE PROCESSORS ACROSS A PLURALITY OF ENDPOINT DEVICES

(71) Applicant: Lenovo Enterprise Solutions (Singapore) Pte. Ltd., Singapore (SG)

(72) Inventors: Fred Allison Bower, III, Durham, NC (US); Caihong Zhang, Shanghai (CN); Andrew Jack Sloma, Austin, TX (US)

(21) Appl. No.: 15/596,941

(22) Filed: May 16, 2017

(51) Int. Cl. G06F 9/48

(52) U.S. Cl. CPC G06F 9/4806

(57) ABSTRACT

Separate embodiments include a management server and an endpoint device with a service processor that may communicate with the management server and service processors on other endpoint devices over a management network. The management server may identify service processors having a corresponding storage device with an amount of available storage space and send a portion of a file to each of the service processors for storage. A plurality of endpoint devices may receive and store a file portion and send a copy of the file portion to a target endpoint device upon request. When the management server selects a target endpoint device to receive the file, the service processor of the target endpoint device may receive a message from the management server instructing the service processor to obtain an identified file, broadcast a request for file portions over the management network, and receive file portions from the other service processors.

### BACKGROUND

The present disclosure relates to management of endpoints devices within a management network.

### BACKGROUND OF THE RELATED ART

In the management of a computer network, it is common to have deployment and maintenance activities coordinated by dedicated management controllers within each of the endpoint devices. These activities are often centrally coordinated from a management server or set of management servers and may be network-intensive. For example, the deployment of operating system images and updates may require a copy of the deployed image to be provided to any number of endpoint devices. This presents a scalability problem for the network connection of the management server to the managed endpoints.

### BRIEF SUMMARY

One embodiment provides an apparatus comprising a storage device for storing program instructions and a processor for processing the program instructions to: identify a plurality of service processors that are accessible over a management network, wherein each service processor is operatively coupled to a corresponding data storage device; determine an amount of available data storage space on each data storage device; and send a portion of a file to each of the service processors for storage in the corresponding data storage device, wherein the portion sent to each service processor has a size that is less than or equal to the amount of available data storage space of the corresponding data storage device.)

Another embodiment provides an apparatus comprising a storage device for storing program instructions and a service processor for processing the program instructions to: receive a file portion from a management server over a management network; store the file portion on a data storage device operatively coupled to the service processor; and send a copy of the file portion to a service processor of a target endpoint device over the management network in response to receiving a request from the service processor of the target endpoint device.

A further embodiment provides an apparatus comprising a storage device for storing program instructions and a service processor for processing the program instructions to: receive a message from a management server over a management network, wherein the message instructs the processor to obtain an identified file; broadcast a request for portions of the identified file to a plurality of other service processors over the management network; and receive file portions over the management network from the other service processors that are operatively coupled to a data storage device storing a portion of the identified file.

### BRIEF DESCRIPTION OF THE SEVERAL VIEWS OF THE DRAWINGS

FIG. 1 is a system diagram of a management network including a management server and a plurality of endpoint devices illustrating the distribution of file portions.

FIG. 2 is a system diagram of the management network of FIG. 1 illustrating an endpoint target device receiving an instruction from the management server and broadcasting a request for the file portions from other endpoint devices.

FIG. 3 is a system diagram of the management network of FIG. 2 illustrating the other endpoint devices sending a copy of the file portions to the endpoint target device.

FIG. 4 is a diagram of actions that may be performed by a processor of the management server.

FIG. 5 is a diagram of actions that may be performed by a service processor of any endpoint device having available data storage space.

FIG. 6 is a diagram of actions that may be performed by a service processor of the target endpoint device.

### DETAILED DESCRIPTION

Embodiments may eliminate bottlenecks that can occur in a management network during management tasks that involve distribution of large files by using available storage space associated with service processors on managed endpoints within the management network. Often, an economically-optimal flash storage device for the managed endpoint has more capacity than the management code requires. Although the available (i.e., not currently in use) storage space is typically less than the large file size required for a management task, such as an OS deployment or update, a file may be stored across the storage space associated with the service processors on a plurality of managed endpoints.

For example, a computer system may include a plurality of endpoint devices or nodes, such as a cluster of servers, and a management server that communicates over a management network with a service processor on each of the servers. After determining an amount of available storage space associated with the service processor of various managed endpoints, the management server splits the file associated with a management task into slices that fit the available space on endpoints. Each slice is then sent to the service processor of one of the endpoints for storage. The distributed storage of slices of the file means that the file may be obtained by any number of endpoints in the management network without causing a network bottleneck at the management server.

Upon direction from the management server, a service processor on a target endpoint may initialize a virtual device (for example, a virtual CD-ROM device) to act as the local copy of a file needed for a selected management task. The virtual device driver may use a broadcast protocol to request slices of the file on demand from other service processors in the management network. Any available slice of the file may be served from a peer within the management network. In situations where a peer with the needed slice is unavailable, the virtual device driver may request the needed slice from the management server. The net effect is a reduction or elimination of requests for file data from the management server, thus allowing the management server to manage a much greater scale of devices in the datacenter. If the cumulative total of available storage space associated with the service processors is sufficient, embodiments may store a redundant copy of each slice on different endpoints, such that unavailability of a single endpoint does not require that the slice be requested from the management server.

### Management Server

One embodiment provides an apparatus comprising a storage device for storing program instructions and a processor for processing the program instructions to: identify a plurality of service processors that are accessible over a management network, wherein each service processor is operatively coupled to a corresponding data storage device; determine an amount of available data storage space on each data storage device; and send a portion of a file to each of the service processors for storage in the corresponding data storage device, wherein the portion sent to each service processor has a size that is less than or equal to the amount of available data storage space of the corresponding data storage device. It should be recognized that the memory device may include multiple memory devices operating together to store the program instructions. It should also be recognized that the processor may include multiple processors operating together to process the program instructions.

A service processor may, for example, be referred to by various names, such as a management controller, baseboard management controller (BMC), or integrated management module (IMM). The service processor is an out-of-band device that manages an interface between system-management software and platform hardware. While the service processor may perform a variety of management functions, such as system monitoring and power control, the service processor may also perform tasks at the direction of system-management software running on a management server. For example, the service processor may report endpoint operating conditions to the management server and may initiate software updates on the endpoint. The endpoint will also include a data storage device that is operatively coupled to the service processor and managed by the service processor, such as a flash data storage device that stores management software that is run by the service processor. Optionally, the file may be selected from a full operating system image or an operating system update.

The processor of the management server may further process the program instructions to instruct a service processor of a target endpoint device to obtain the file by requesting, for each of the file portions, the file portion from the service processor having a corresponding data storage device that stores the file portion, wherein the file portions collectively form the file. A management network is provided between the management server and a service processor on each endpoint device. The target endpoint device may be selected by the management server for the purpose of providing or updating software or a data file, such as a new endpoint device.

In another embodiment, the processor of the management server may further process the program instructions to identify a remaining portion of the file that has not been sent to any of the service processors for storage in the corresponding data storage device. Since the target endpoint device will not be able to obtain the remaining portion of the file from the service processors of other endpoints in this situation, the management server will be responsible for providing the remaining portion of the file any time that the target endpoint device needs the file. For example, the processor of the management server may further process the program instructions to instruct a service processor of a target endpoint device to request, for each of the file portions, the file portion from the service processor having a corresponding data storage device that stores the file portion, and send the remaining portion of the file to the service processor of the target endpoint device.

Optionally, the management server may take responsibility for providing any portion of the file that the target endpoint device is unable to obtain from other endpoint devices, perhaps due to the relevant endpoint being powered off, having temporarily replaced the file portion, or having lost connection with the management network. Typically, the service processor and the associated data storage will be operational on auxiliary power to support management tasks even if the main power to the endpoint device has been turned off. In one specific implementation, the processor of the management server may further process the program instructions to identify one of the file portions that the service processor of the target endpoint device is unable to obtain from among the plurality of service processors, and send the identified file portion to the service processor of the target endpoint device.

On occasion, the management server may determine that the data storage space associated with the service processors of certain endpoint devices should be used to store a different file, perhaps associated with a different management task. According to one embodiment, the processor of the management server may further process the program instructions to: instruct a service processor from among the plurality of service processors to replace the file portion with a portion of a second file, and send the portion of the second file to the service processors for storage in the corresponding data storage device.

### Endpoint Device

Another embodiment provides an apparatus comprising a storage device for storing program instructions and a service processor for processing the program instructions to: receive a file portion from a management server over a management network; store the file portion on a data storage device operatively coupled to the service processor; and send a copy of the file portion to a service processor of a target endpoint device over the management network in response to receiving a request from the service processor of the target endpoint device. It should be recognized that the memory device may include multiple memory devices operating together to store the program instructions. It should also be recognized that the processor may include multiple processors operating together to process the program instructions.

The size of any given file portion must be less than the available storage space (i.e., storage space not currently in use) of the data storage device where the file portion is being stored. After receiving and storing the file portion, the service processor may send a copy of the file portion in response to requests received over the management network from a service processor on any of the other endpoint devices. In this respect, the service processor functions as a file server for the particular file portion stored on the associated data storage device.

### Target Endpoint Device

A further embodiment provides an apparatus comprising a storage device for storing program instructions and a service processor for processing the program instructions to: receive a message from a management server over a management network, wherein the message instructs the processor to obtain an identified file; broadcast a request for portions of the identified file to a plurality of other service processors over the management network; and receive file portions over the management network from the other service processors that are operatively coupled to a data storage device storing a portion of the identified file. It should be recognized that the memory device may include multiple memory devices operating together to store the program instructions. It should also be recognized that the processor may include multiple processors operating together to process the program instructions.

The request for portions of the identified file may be broadcast using any available broadcast protocol. However, embodiments may broadcast the request on the management network so that the relevant service processors will receive the request. In one option, it is not necessary for the target endpoint device to send separate targeted requests to those service processors that have access to the file portions that collectively makeup a complete copy of the requested file. Rather, a request identifying the selected file may be broadcast to each of the service processors in the management network, and those service processors that can provide one of the file portion will respond by either by immediately sending the file portion to the target endpoint device of by identifying themselves to the target endpoint device so that the target endpoint device may subsequently send a targeted request to the identified service processor. The latter approach may provide the benefit of preventing the target endpoint device from experiencing its own bottleneck due to simultaneously receiving multiple file portions.

In one option, the processor of the target endpoint device may further process the program instructions to initialize a virtual device to serve as a local copy of the identified file, and store the received file portions on the virtual device to form a complete copy of the requested file. A virtual device is a software module that emulates the functionality of a physical or logical device within the computer system such that components utilizing the device can not differentiate between the emulated device and the physical or logical component it is emulating. In various embodiments, virtual devices can take the form of a virtual file system driver that emulates a local filesystem for the file portions distributed throughout the management network or virtual disk devices that emulate a physically-attached fixed or removable disk device containing media with the file(s) being supplied by the management server and endpoint service processors.

In another embodiment, after a complete copy of the request file has been obtained, the processor of the target endpoint device may further process the program instructions to perform a local management task involving the local copy of the identified file. Typically, the local management task is the basis upon which the file is requested. For example, the management server may instruct the service processor of the target endpoint device to obtain file portions that makeup a complete copy of a particular file, and then use the file in a particular management task. In one example, the management server may instruct a service processor to obtain a copy of an operating system and then initiate installation of that operating system on the endpoint device.

In a further embodiment, if the target endpoint device is unable to obtain all the file portions necessary to have a complete copy of the file, the target endpoint device may request the missing portion from the management server. For example, the processor of the target endpoint device may further process the program instructions to identify a missing portion of the identified file that the service processor is unable to obtain from among the plurality of other service processors, and send a request for the identified missing portion of the identified file to a management server. In this manner, a copy of the file maintained by the management server may serve as a backup to the file portions that are saved on data storage devices associated with the service processors across the plurality of endpoint devices.

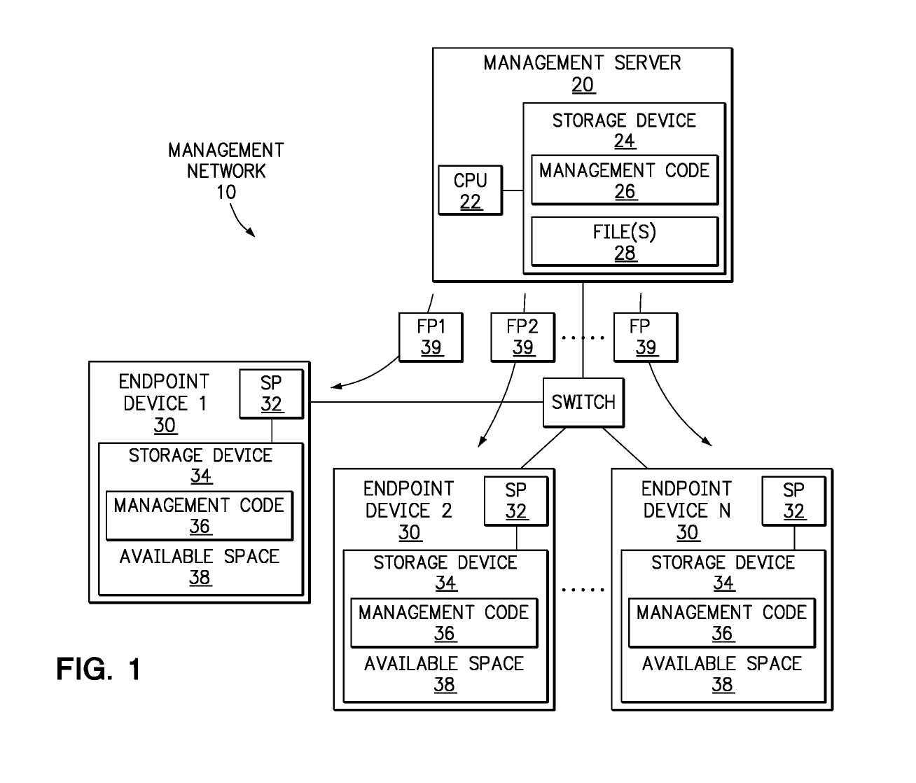

FIG. 1 is a system diagram of a management network 10 including a management server 20 and a plurality of endpoint devices 30 illustrating the distribution of file portions. The management server 20 has a central processor unit (CPU) 22 and a data storage device 24. The data storage device 24 stores management code 26 including program instructions that are processed by the CPU 22 in order to take actions according to one or more embodiments. The data storage device 24 may also store, or otherwise access, one or more files 28 that may be needed for one or more management task involving an endpoint device in the management network 10.

The management network 10 is shown having a plurality of endpoint devices 30. While only three endpoint devices are shown, the management network 10 may include any number of endpoint devices. Specifically, the endpoint devices shown represent a plurality (i.e., 1 through N) of the endpoint devices 30, including Endpoint Device 1, Endpoint Device 2 and so forth through Endpoint Device N. Each endpoint device 30 includes a service processor 32 and a data storage device 34. The service processor 32 can communicate with the management server 20 and other endpoint devices 30 over the network, where each endpoint device 30 has direct access to one of the data storage devices 34. The service processor 32 also has access to the local data storage device 34 which stores management code 36 that may be processed by the service processor 32 to take actions according to one or more embodiments.

The management server 20 may identify a plurality of service processors 32 that are accessible over the management network 10, wherein each service processor 32 is operatively coupled to a corresponding data storage device 34. After determining an amount of available data storage space 38 on each data storage device 34, the management server 20 may divide a file 28 into file portions 39 that can be stored in the data storage space 38 determined to be available on each respective data storage device 34. These file portions 39 may be the same size or may be different sizes depending on the amount of available space 38 on each data storage device 34. However, the management server 20 will send one of the file portions 39 to each of the service processors 32 for storage in the corresponding data storage device 34, wherein the file portion sent to each service processor has a size that is less than or equal to the amount of available data storage space of the corresponding data storage device. As shown, a first file portion (FP1) is sent to Endpoint Device 1, a second file portion (FP2) is sent to Endpoint Device 2, and an Nth file portion (FPN) is sent to Endpoint Device N. Preferably, the entirety of a desired file 28 is collectively stored on the plurality of endpoint devices 30. If there is an insufficient collective amount of available space 38 on the endpoint devices of the management network 10, then the management server 20 may be relied upon to provide any portion of the desired file 28 that isn't stored by the endpoint devices.

A plurality of the endpoint devices 30 may receive a file portion 39 from the management server 20 over the management network 10, and store the received file portion on the data storage device 34 that is operatively coupled to the service processor 32 on each of the endpoint devices 30. Depending upon the total size of the file 28 and the collective amount of available space 38, the file may be stored on fewer than all of the endpoint devices. On the other hand, if the file size is greater than the collective amount of available space, then each endpoint device will preferably store a file portion and the management server 20 may be relied upon for access to any other portion of the file 28. In fact, the management server 20 preferably maintains a complete copy of the file 28 regardless of whether the file portions stored on the endpoint devices comprise a complete copy of the file, so that the management network always has a complete copy of the file 28 available even if one or more of the endpoint devices 30 is offline or otherwise inaccessible at a particular point in time when the file is needed.

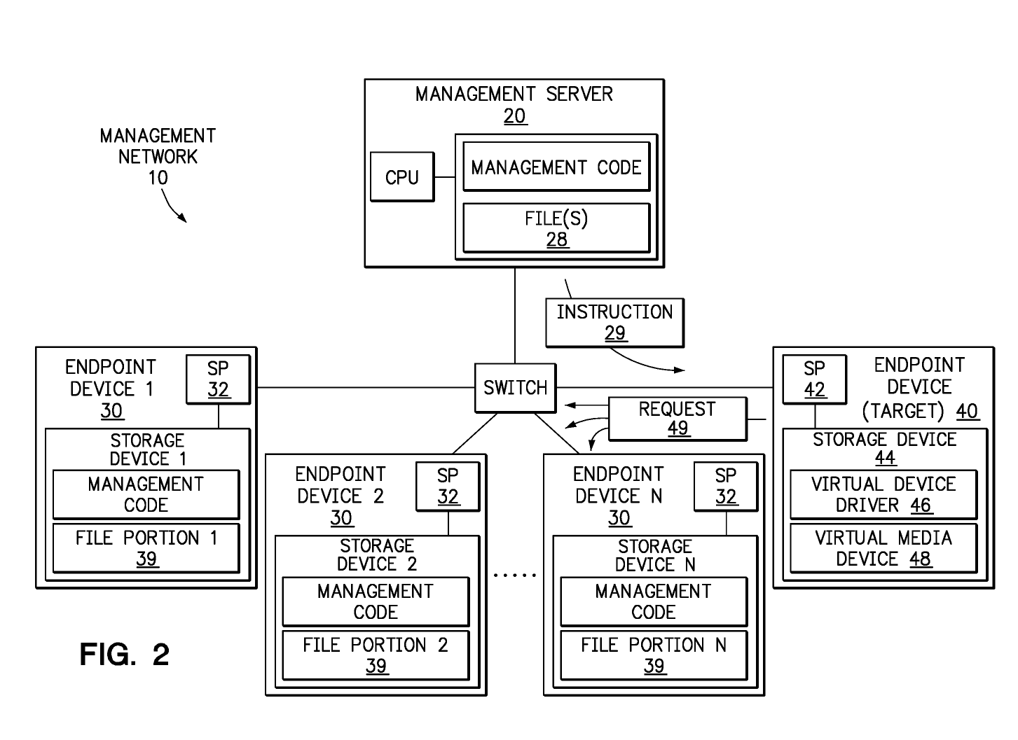

FIG. 2 is a system diagram of the management network 10 of FIG. 1 illustrating an endpoint target device 40 receiving a message or instruction 29 from the management server 20 and broadcasting a request 49 for the file portions 39 from other endpoint devices 30. The message or instruction 29 instructs the service processor 42 of the target endpoint device 40 to obtain the identified file 28 in the form of the file portions 39. Specifically, the service processor 42 may broadcast a request 49 for the file portions 39 of the identified file 28 to the plurality of other service processors 32 over the management network 10. Optionally, the request 49 may be a single request for all file portions related to an identified file, or the request 49 may be a plurality of sequential requests for individual file portions.

The target endpoint device 40 has a data storage device 44. In one option, the data storage device 44 includes a virtual device driver 46, which may be preloaded or obtained from the management server 20, and a virtual media device 48. The virtual device driver or other management code of the service processor 42 may be processed to send the request, manage the receipt of file portions, and send any subsequent request for a portion of the file that has not been received.

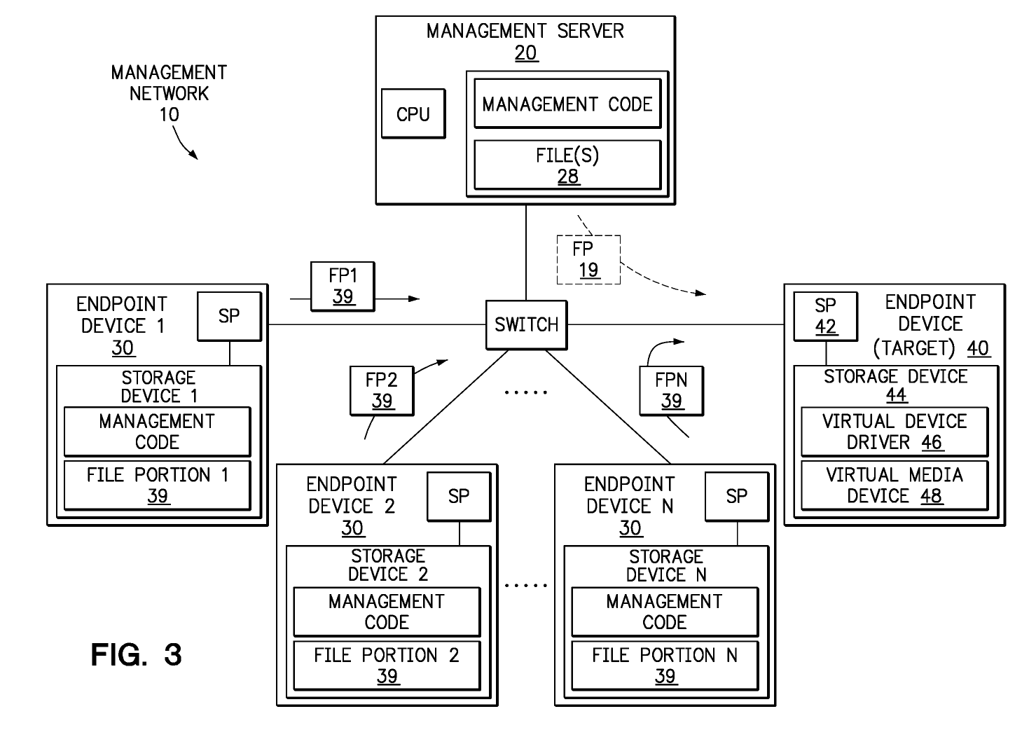

FIG. 3 is a system diagram of the management network of FIG. 2 illustrating the other endpoint devices 30 sending a copy of the respective file portions 39 to the endpoint target device. The file portions 39 are received and stored in the virtual media device 48. If any portion of the file 28 is not received as a file portion 39, the target endpoint device 40 may request the remaining portion of the file (see file portion 19) from the management server 20. Any file portion 19 optionally requested from the management server 20 may be the same as a file portion 39 that was not received due to one of the endpoint devices being offline or otherwise didn't respond to the request 49, or the optionally requested file portion 19 may be a portion of the file 28 that is only available from the management server 20 due to the file size being greater than the collective amount of storage space that was available on the plurality of endpoint devices 30 when the file portions 39 were sent to the endpoints to be stored. Upon receipt of the complete file 28, the service processor 42 may process a management task, preferably at the request of the management server 20. Optionally, the initial instruction 29 (see FIG. 2) from the management server 20 may have instructed the service processor 42 what to do with the file in response to receiving the complete file.

It should be recognized that any file portion 39 that can be served from one of the endpoint devices 30 to the target endpoint device 40 is a file portion that does not need to be sent by the management server 20. Accordingly, a network interface that the management server 20 uses to communicate over the management network 10 will experience less network traffic.

As previously disclosed, the file being provided to the target endpoint device 40 may be an operating system image. Furthermore, the target endpoint device 40 can get multiple file(s) or images from the management network 10 provided available storage on the other endpoints permits it. Additionally, the file portions or images stored can be changed to accommodate a specific set of management tasks over a short time period. For example, during an update window, the file portions or images can be the update elements being flashed, whereas during normal operation the stored file portions or images may be a preferred operating system image. It should be recognized that embodiments of the system may be beneficially used to deploy one or more files to new (target) endpoint devices in a managed network.

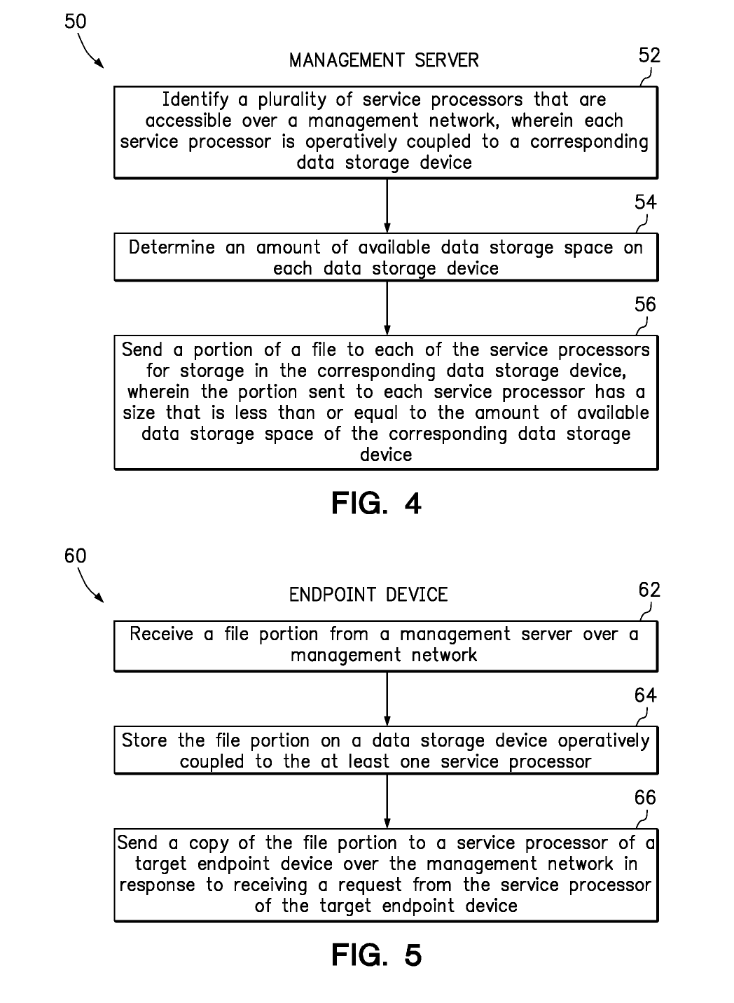

FIG. 4 is a diagram of actions 50 that may be performed by a processor of the management server. The management server may comprise a storage device for storing program instructions and a processor for processing the program instructions to: identify a plurality of service processors that are accessible over a management network, wherein each service processor is operatively coupled to a corresponding data storage device (block 52); determine an amount of available data storage space on each data storage device (block 54); and send a portion of a file to each of the service processors for storage in the corresponding data storage device, wherein the portion sent to each service processor has a size that is less than or equal to the amount of available data storage space of the corresponding data storage device (block 56).

FIG. 5 is a diagram of actions 60 that may be performed by a service processor of any endpoint device having available data storage space. The endpoint device may comprise a storage device for storing program instructions and a service processor for processing the program instructions to: receive a file portion from a management server over a management network (block 62); store the file portion on a data storage device operatively coupled to the service processor (block 64); and send a copy of the file portion to a service processor of a target endpoint device over the management network in response to receiving a request from the service processor of the target endpoint device (block 66).

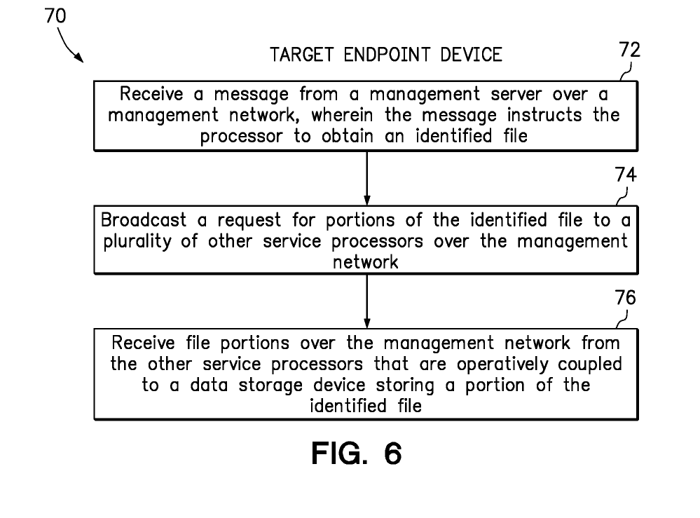

FIG. 6 is a diagram of actions 70 that may be performed by a service processor of the target endpoint device. The target endpoint device may comprise a storage device for storing program instructions and a service processor for processing the program instructions to: receive a message from a management server over a management network, wherein the message instructs the processor to obtain an identified file (block 72); broadcast a request for portions of the identified file to a plurality of other service processors over the management network (block 74); and receive file portions over the management network from the other service processors that are operatively coupled to a data storage device storing a portion of the identified file (block 76).

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
a storage device for storing program instructions; and
a processor for processing the program instructions to:
identify a plurality of service processors that are accessible over a management network, wherein each service processor is operatively coupled to a corresponding data storage device;
determine an amount of available data storage space on each data storage device; and
send a portion of a file to each of the service processors for storage in the corresponding data storage device, wherein the portion sent to each service processor has a size that is less than or equal to the amount of available data storage space of the corresponding data storage device.

2. The apparatus of claim 1, the processor for further processing the program instructions to:
instruct a service processor of a target endpoint device to obtain the file by requesting, for each of the file portions, the file portion from the service processor having a corresponding data storage device that stores the file portion, wherein the file portions collectively form the file.

3. The apparatus of claim 1, the processor for further processing the program instructions to:
identify a remaining portion of the file that has not been sent to any of the service processors for storage in the corresponding data storage device.

4. The apparatus of claim 3, the processor for further processing the program instructions to:
instruct a service processor of a target endpoint device to request, for each of the file portions, the file portion from the service processor having a corresponding data storage device that stores the file portion; and
send the remaining portion of the file to the service processor of the target endpoint device.

5. The apparatus of claim 3, the processor for further processing the program instructions to:
identify one of the file portions that the service processor of the target endpoint device is unable to obtain from among the plurality of service processors; and
send the identified file portion to the service processor of the target endpoint device.

6. The apparatus of claim 1, wherein each data storage device is a flash data storage device.

7. The apparatus of claim 1, wherein the file is selected from a full operating system image or a hardware update.

8. The apparatus of claim 1, the processor for further processing the program instructions to:
instruct a service processor from among the plurality of service processors to replace the file portion with a portion of a second file; and
send the portion of the second file to the service processors for storage in the corresponding data storage device.

9. An apparatus, comprising:
a storage device for storing program instructions; and
a service processor for processing the program instructions to:
receive a file portion from a management server over a management network;
store the file portion on a data storage device operatively coupled to the service processor; and
send a copy of the file portion to a service processor of a target endpoint device over the management network in response to receiving a request from the service processor of the target endpoint device.

10. An apparatus, comprising:
a storage device for storing program instructions; and
a service processor for processing the program instructions to:
receive a message from a management server over a management network, wherein the message instructs the processor to obtain an identified file;
broadcast a request for portions of the identified file to a plurality of other service processors over the management network; and
receive file portions over the management network from the other service processors that are operatively coupled to a data storage device storing a portion of the identified file.

11. The apparatus of claim 10, the processor for further processing the program instructions to:
initialize a virtual device to serve as a local copy of the identified file; and
store the received file portions on the virtual device to form a complete copy of the requested file.

12. The apparatus of claim 11, the processor for further processing the program instructions to:
perform a local management task involving the local copy of the identified file.

13. The apparatus of claim 12, wherein the identified file is an operating system image and the local management task is deployment of the operating system image.

14. The apparatus of claim 12, wherein the identified file is firmware and the local management task is updating the firmware of a hardware device.

15. The apparatus of claim 11, the processor for further processing the program instructions to:
identify a missing portion of the identified file that the service processor is unable to obtain from among the plurality of other service processors; and
send a request for the identified missing portion of the identified file to a management server.

16. The apparatus of claim 10, wherein each data storage device is a flash data storage device.

17. The apparatus of claim 10, wherein the file is selected from a full operating system image or a hardware firmware update.
